(19) United States
(12) Patent Application Publication
(10) Pub. No.: US 2002/0078240 A1
(43) Pub. Date: Jun. 20, 2002

(54) Method and system for verifying a link between an application accessing a communications device and a device controlling the access

(76) Inventors: Michael Ehrlich, Recklinghausen (DE); Otto Schroter, Essen (DE)

Correspondence Address: BELL, BOYD & LLOYD, LLC, P. O. BOX 1135, CHICAGO, IL, 60690-1135, US

(21) Appl. No.: 09/954,322

(22) Filed: Sep. 14, 2001

(30) Foreign Application Priority Data
Sep. 14, 2000 (DE) 100 45 558.1

(51) Int. Cl. G06F 15/16

(52) U.S. Cl. 709/245; 709/203

(57) ABSTRACT

A method and system for verifying a link between an application accessing a communications device and a device controlling the access wherein operation-maintained messages are exchanged between the application and the device, and in cases in which no operation-maintained message has been received from the application and/or the device after a predefinable period of time has expired, configurable error recovery is initiated which includes, for example, terminating the link between the application and the communications device, restarting the application and issuing information about the failure or the malfunction of the application.

### BACKGROUND OF THE INVENTION

The present invention relates, in particular, to a method and a system for verifying a link between what is referred to as a “TAPI application” (Telephony Application Programming Interface) and a “TAPI service provider”.

The transmission of data from an application running on a Windows-based data processing device (for example, a personal computer) via a communications network (for example, via an ISDN network or a mobile radio network) is generally controlled by what is referred to as a TAPI (Telephony Application Programming Interface) driver integrated in the data processing system. TAPI constitutes here a software interface which permits access from applications running on a Windows-based data processing device to a connecting unit of the data processing device which makes the connection to a communications network. A standardized set of instructions is defined for the TAP interface for such a case.

In what is referred to as a “Client/Server architecture”, the individual data processing devices which are referred to as “clients” do not have any direct connection to a communications system or to the communications network. The connection to the communications system or to the communications network is made by a central device which is referred to as a “server” and which is connected, for example, via a local network (LAN) (Local Area Network) to the data processing devices.

Such a central device is frequently referred to in the literature as a “TAPI Service Provider”, TSP for short.

In order to transmit data to the communications system or via the communications network from an application running on the data processing device, the instructions which are output by the application and the data which is to be transmitted are transmitted to the central device via the TAP interface of the data processing device, the local network LAN and the TAPI interface of the central device, the central device setting up an application-specific link to the communications system or via the communications network.

In such a case, the application implements communication-system-specific functions, for example call toll registration, telephone directory functions or ACD (Automatic Call Distribution) functions, depending on the type of application. When a number of these communication-system-specific functions are implemented, for example when ACD functions are implemented, the respective application and the communications system are in a permanent, alternating relationship with one another; i.e., there is permanently a bidirectional exchange of information between the application and the communications system via the central device (TAPI Service Provider).

If, in the process, a malfunction of the application occurs or, in an extreme case, the application crashes, the bidirectional exchange of information by the application is interrupted in an unscheduled fashion. The central device (TAPI Service Provider) does not have any safeguarding device which detects such a malfunction or crash of the application, and it continues to wait for messages from the application. Owing to the failure to detect the malfunction or the crashing of the application, malfunctions of the “TAPI Service Provider” and/or of the communications system thus also occur so that it is not possible to ensure that subsequent actions or acquired data are correct.

The present invention is, therefore, directed toward providing measures which detect a malfunction or a crash of an application and can take suitable measures.

### SUMMARY OF THE INVENTION

Accordingly, in an embodiment of the present invention, a method is provided for verifying a link between an application accessing a communications device and a control device controlling the access, in which operation-maintained messages are exchanged between the application and the control device, and in which error recovery is initiated in cases in which no operation-maintained message is received from the application and/or the control device after a predefinable period of time has expired.

In an embodiment, the application accesses the communications device via a Telephony Application Programming Interface (TAPI).

In an embodiment, the link between the application and the communications device is terminated and a communications-system-internal application is started.

In an embodiment, the control device transmits a failure message to defined communications terminals via the communications device.

In an embodiment, the failure message is transmitted in the form of a Short Message Service (SMS) to a mobile phone.

In an embodiment, a failure message is displayed on a display device of a data processing device on which the application runs.

In an embodiment, the control device enters an error message into a logbook.

In an embodiment, the control device terminates the application and subsequently restarts it.

In another embodiment of the present invention, a system is provided for verifying a link between an application accessing a communications device and a control device for controlling the access, which includes a central unit implemented in the control device for exchanging operation-maintained messages between the application and the control device, and for initiating error recovery when no operation-maintained message is received from the application after a predefinable period of time has expired.

In an embodiment, the central unit has a configuration unit for setting up the error recovery to be performed.

In an embodiment, the application is a Telephony Application Programming Interface (TAPI) application.

In an embodiment, the application is implemented in a data processing device connected to the control device via a local network.

In an embodiment, the application is implemented in the control device.

A significant advantage of the method according to the present invention is that the method easily can be integrated into already existing systems.

An advantage of refinements of the present invention is, inter alia, the fact that the possibility of individually configuring a central unit permits a reaction to a malfunction (for example, to a crash) of an application to be set up in any desired fashion.

A further advantage of refinements of the present invention is that the use of a TAPI (Telephony Application Programming Interface) for communication between an application running on a data processing device and the communications device makes it possible to use data processing devices with the widespread “Windows” operating system from Microsoft.

Additional features and advantages of the present invention are described in, and will be apparent from, the following Detailed Description of the Invention and Figures.

### BRIEF DESCRIPTION OF THE FIGURES

FIG. 1 shows a structural diagram representing schematically the essential functional units involved in the method according to the present invention.

FIG. 2 shows a Windows mask which can be used to configure the error recovery to be performed when an application malfunctions.

### DETAILED DESCRIPTION OF THE INVENTION

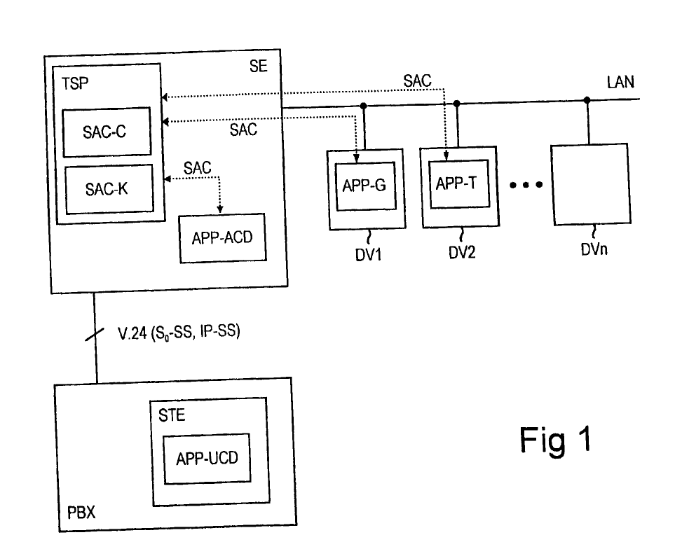

FIG. 1 shows a server device SE and a number of data processing devices DV1, . . . , DVn (frequently referred to in this context in the literature as “Clients”) which are connected to one another via a local network LAN (Local Area Network). Data is transmitted over the local network LAN in accordance with the known IP protocol (Internet Protocol). Furthermore, the server device SE is connected to a communications system PBX via a V.24 interface. Alternatively, the server device SE also can be connected to the communications system PBX via an ISDN-oriented interface, for example a S₀ interface, or an IP-oriented interface (indicated by S₀-SS and IP-SS in brackets).

Applications APP which access the communications system PBX run on the “Windows” operating system from Microsoft both on the data processing devices DV1, . . . , DVn and on the server device SE. The applications APP access the communication system PBX here via what is referred to as a TAPI interface implemented, in each case, in the server device SE and the data processing devices DV1, . . . , DVn. For example, an application APP-G for registering call tolls runs on a first data processing device DV1, and a telephone directory application APP-T for automatic connection set-up via the communication system PBX on the basis of call number information selected via the application APP-T runs on a second data processing device DV2. An application APP-ACD for automatic call distribution (ACD) runs on the server device SE, the application APP-ACD controlling the distribution of calls which are incoming on the communications system PBX. Furthermore, an application APP-UCD (Universal Call Distribution) for call distribution of the calls which are incoming on the communications system PBX is also implemented in a control unit STE of the communications system PBX, the application APP-UCD being activated only in cases in which the application APP-ACD, implemented in the server device SE for automatic call distribution is deactivated or fails.

The exchange of data between the communications system PBX and the respective applications APP-ACD, APP-G, APP-T is controlled here by a central unit TSP; frequently referred to in the literature as “TAPI Service Provider” which runs on the server device. Bidirectional transmission of data between the central unit TSP and the communications system PBX takes place, by way of example, in accordance with the CSTA (Computer Supported Telecommunications Application) protocol. Data is transmitted bidirectionally between the central unit TSP and the applications APP-ACD, APP-G, APP-T by accessing TAPI library functions; frequently referred to in the literature as “Dynamic Link Library”, DLL for short, which are not illustrated.

The central unit TSP includes essentially a supervisory unit SAC-C and a configuration unit SAC-K. The supervisory unit SAC-C transmits, on the one hand, operation-maintained messages SAC (Still Alive Control) at adjustable time intervals to the applications APP-ACD, APP-G, APP-T running on the server device SE and the data processing devices DV1, . . . , DVn. On the other hand, the supervisory unit SAC-C checks whether operation-maintained messages SAC are transmitted back to the central unit TSP by the applications APP-ACD, APP-G, APP-T within the time intervals. If no operation-maintained messages SAC are received by the currently running applications APP-ACD, APP-G, APP-T within this time interval, it is assumed that an error has occurred during the processing of the application APP-ACD, APP-G, APP-T, or the respective application APP-ACD, APP-G, APP-T has even crashed, and error recovery which is defined by the configuration unit SAC-K is initiated.

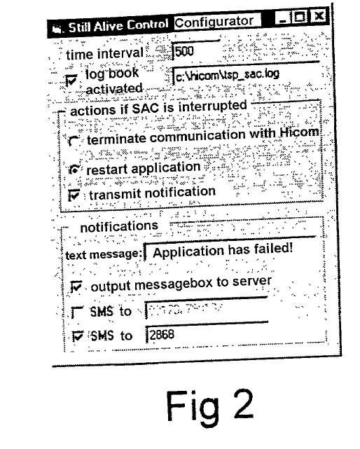

FIG. 2 shows a Windows mask, presented by the configuration unit SAC-K on a display device, for example a monitor, of the server device SE, via which mask configuration of the error recovery to be performed in the event of a malfunction of an application APP-ACD, APP-G, APP-T is made possible.

Through the configuration unit SAC-K it is possible to adjust the time interval for dispatching and receiving the operation-maintained messages SAC by the control unit SAC-C. In the present exemplary embodiment, a time interval of 500 ms is selected. Furthermore, it is possible to select whether a log book is to be kept in which the communication is to be stored for subsequent checking; for example, in the case of the occurrence of an error. If this is the case, it is possible to specify in a directory of the server device SE a file in which the communication between the safeguarding device TSP and the applications APP-ACD, APP-G, APP-T are stored. In the present exemplary embodiment, the communication is stored in a file “tsp_sac.log”, in the directory “c:\hicom\ . . . ” of the server device SE.

In addition, in the Windows mask illustrated, it is possible to select which actions are to be carried out by the safeguarding device TSP if a malfunction of an application APP-ACD, APP-G, APP-T has occurred; i.e., if the transmission of the operation-maintained messages SAC is interrupted. Here, it is possible to select whether the link (communication) between the respective application APP-ACD, APP-G, APP-T and the communications system PBX (Hicom) is terminated, or whether the respective application APP-ACD, APP-G, APP-T is restarted. Furthermore, a notification function can be activated and deactivated. In cases in which there is provision for the communication between the respective application APP-ACD, APP-G, APP-T and the communications system PBX to be terminated, additional communications-system-specific functions can be activated. For example, in the present exemplary embodiment, in the event of a failure of the application APP-ACD running in the server device SE the application APP-UCD implemented in the communications system PBX is activated and the calls which are incoming on the communications system PBX are distributed by this application APP-UCD. This is appropriate, in particular, for applications APP-ACD whose failure is not noticed immediately by a subscriber.

When the notification function is activated, a text (for example, “application has failed!”) can be entered, and it is transmitted to a subscriber when a notification is issued. Furthermore, the type of notification can be set. For example, it is possible to select that a notification Window (“messagebox”) is displayed on a display device, for example a monitor, of the server device SE or of a data processing device DV1, . . . DVn, or that an SMS (Short Message Service) is transmitted to a call number which can be entered. In the present exemplary embodiment, both a notification window with the text “application has failed!” is displayed on a display device of the respective server device SE or data processing device DV1, . . . , DVn and an SMS is transmitted to the communications-system-intemal terminal with the call number 2868. In this way, a subscriber is informed immediately of a failure or a malfunction of an application APP-ACD, APP-G, APP-T so that the subscriber can take measures which may be additionally necessary.

Although the present invention has been described with reference to specific embodiments, those of skill in the art will recognize that changes may be made thereto without departing from the spirit and scope of the invention as set forth in the hereafter appended claims.

1. A method for verifying a link between an application accessing a communications device and a control device controlling the access, the method comprising the steps of:
exchanging operation-maintained messages between the application and the control device; and
initiating error recovery if no operation-maintained message is received for at least one of the application and the control device after a predefinable period of time is expired.

2. A method for verifying a link between an application accessing a communications device and a control device controlling the access as claimed in claim 1, the method further comprising the step of:
accessing the communications device, by the application, via a Telephony Application Programming Interface.

3. A method for verifying a link between an application accessing a communications device and a control device controlling the access as claimed in claim 1, the method further comprising the step of:
terminating, within a scope of the error recovery by the control device, the link between the application and the communications device and starting a communications-system-internal application.

4. A method for verifying a link between an application accessing a communications device and a control device controlling the access as claimed in claim 1, the method further comprising the step of:
transmitting, by the control device, a failure message to defined communications terminals via the communications device.

5. A method for verifying a link between an application accessing a communications device and a control device controlling the access as claimed in claim 4, wherein the failure message is transmitted in the form of a Short Message Service to a mobile phone.

6. A method for verifying a link between an application accessing a communications device and a control device controlling the access as claimed in claim 4, the method further comprising the step of:
displaying a failure message on a display device of a data processing device on which the application runs.

7. A method for verifying a link between an application accessing a communications device and a control device controlling the access as claimed in claim 1, wherein the control device enters an error message into a logbook.

8. A method for verifying a link between an application accessing a communications device and a control device controlling the access as claimed in claim 1, wherein the control device terminates the application and subsequently restarts it.

9. A system for verifying a link between an application accessing a communications device and a control device controlling the access, comprising a central unit implemented in the control device, the central unit for exchanging operation-maintained messages between the application and the control device, and for initiating error recovery when no operation-maintained message is received from the application after a predefinable period of time has expired.

10. A system for verifying a link between an application accessing a communications device and a control device controlling the access as claimed in claim 9, wherein the central unit has a configuration unit for setting up the error recovery to be performed.

11. A system for verifying a link between an application accessing a communications device and a control device controlling the access as claimed in claim 9, wherein the application is a Telephony Application Programming Interface.

12. A system for verifying a link between an application accessing a communications device and a control device controlling the access as claimed in claim 11, wherein the application is implemented in a data processing device connected to the control device via a local network.

13. A system for verifying a link between an application accessing a communications device and a control device controlling the access as claimed in claim 11, wherein the application is implemented in the control device.
